(19) United States
(12) Patent Application Publication
(10) Pub. No.: US 2006/0032281 A1
(43) Pub. Date: Feb. 16, 2006

(54) Soil conditioner

(76) Inventor: Alan Meyer, Brisbane (AU)

Correspondence Address: GIFFORD, KRASS, GROH, SPRINKLE & CITKOWSKI, P.C, PO BOX 7021, TROY, MI, 48007-7021, US

(21) Appl. No.: 10/915,243

(22) Filed: Aug. 10, 2004

(51) Int. Cl. C05F 11/08

(52) U.S. Cl. 71/6

(57) ABSTRACT

A soil conditioner has been developed that includes a bacterial culture endogenous to plants that includes nitrogen present from 0.20 weight percent per volume, 30 to 250 milligrams per liter phosphorus and 400 to 20,000 milligrams per liter of potassium. The soil conditioner stimulates earthworm population growth and activity in a treated soil. The soil conditioner also has applications as a livestock nutrient supplement and as a degradant for oil spills. A process for preparing a soil conditioner involves composting a manure with at least one plant fermentation inoculant to yield a composted mixture. The composted mixture is then fermented in combination with a nitrogenous protein source and seaweed.

### FIELD OF THE INVENTION

The present invention in general relates to a process for producing a soil conditioner and the resulting composition, and in particular to a fermented soil conditioner containing robust microbial flora.

### BACKGROUND OF THE INVENTION

The fertilization of plants is as old as human civilization. The notion of supplementing soil with bioavailable nitrogen, phosphorus, potassium and minerals to stimulate robust plant growth is well known. As a result, plants have been fertilized with manures, vegetive composts, seaweed, fish and animal byproducts, and synthetic fertilizer compositions. While all these approaches have met with a degree of success, there is a growing appreciation that improved plant growth and management of soil nutrients is obtained by promoting a vibrant soil ecosystem in the vicinity of plants. A thriving soil ecosystem promotes the breakdown of complex substances into a form in which the nutrients contained therein are available to the plant. Additionally, the soil ecosystem through metabolism tends to meter nutrients to the plant at a rate that promotes better plant growth, as compared to soil dosing with water soluble nutrients.

Manure and other waste products have become ineffective fertilizers in the modern world owing to contaminating surfactants, antibiotics and other byproducts of modern society. These contaminants not only slow breakdown but also challenge the existence of the organisms making up the soil ecosystem. Thus, there exists a need for a soil conditioner that either introduces more hardy organisms into the soil ecosystem and/or provides nutrients to stimulate existing soil organisms such as bacteria, fungi and roundworms that in turn generate nutrients accessible to plants.

### SUMMARY OF THE INVENTION

A soil conditioner has been developed that includes a bacterial culture endogenous to plants that includes nitrogen present from 0.20 weight percent per volume, from 30 to 250 milligrams per liter phosphorus and from 400 to 20,000 milligrams per liter of potassium. The soil conditioner stimulates earthworm population growth and activity in a treated soil. The soil conditioner also has applications as a livestock nutrient supplement and as a degradant for oil spills and other remediation applications. A process for preparing a soil conditioner involves composting a manure with at least one plant fermentation inoculant to yield a composted mixture. The composted mixture is then fermented in combination with a nitrogenous protein source and seaweed.

### BRIEF DESCRIPTION OF THE DRAWING

FIG. 1 is a schematic illustrating a process by which an inventive soil conditioner is produced.

### DETAILED DESCRIPTION OF THE PREFERRED EMBODIMENTS

The present invention has utility as a process for, and the composition of, a substance enhancing the ability of a soil to support plant growth. According to the present invention, a manure is first composted in the presence of a composting inoculant derived from living plants. A protein and nitrogen rich material is added to the composted mixture along with seaweed. Thereafter, fermentation yields a nutrient-rich liquid that stimulates plant growth in a soil treated with the resulting composition. The inventive composition also is operative as a livestock nutrient supplement or an oil spill degradant and other remediation applications.

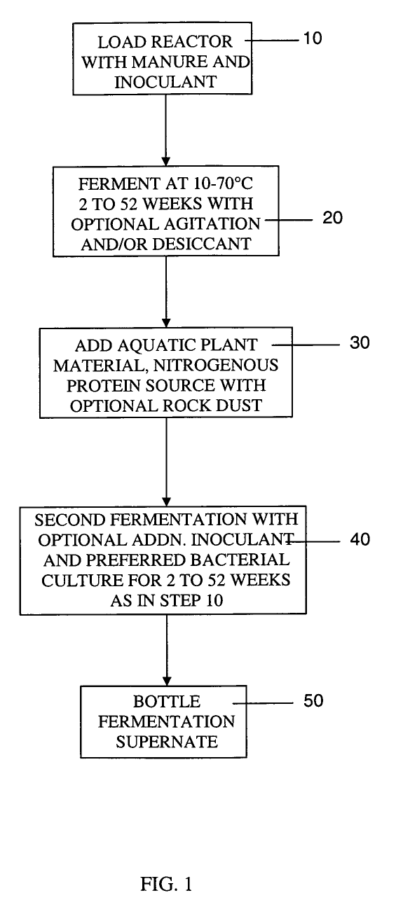

Referring now to FIG. 1, a process by which an inventive composition is produced is shown in schematic form. A reactor is initially loaded with manure and a plant derived microbial inoculant 10. A manure operative herein illustratively includes that from human, cow, pig, sheep, fowl, mushroom compost, and combinations thereof. Preferably, the manure is certified organic. The plant derived composting inoculant includes bacteria and fungi that naturally populate the plant chosen as an inoculant. A composting inoculant is readily derived from various plant portions or a plant as a whole and includes buds, leaves, flowers, bark, roots and combinations thereof. It is also appreciated that the bacterial and fungal population colonizing a plant varies throughout the day and seasonally. A composting inoculant is illustratively derived from a plant or portion thereof illustratively including yarrow, oak, nettle, thistle, dandelion, valerian, equisetum, chamomile, comfrey or combinations thereof. Preferably, the plant that serves as the inoculant is grown under climatic stress and/or nutrient-poor soil. The manure-inoculant is allowed to compost with optional agitation and/or desiccant for 2 to 52 weeks. The compost mixture initially heats up to about 65 to 70 degrees Celsius before cooling to a static temperature of between 15 and 30 degrees Celsius, depending on the external temperature and the biological activity of the mixture. Alternatively, the manure-inoculant is composted through processing in a worm farm for a time of between 2 weeks and 2 years.

It is appreciated that uniform composting throughout the volume is promoted by mixture agitation. The mode of agitation is recognized to be dependent upon the compost mixture volume with mechanical mixing, and reactor inversion being illustrative examples of mixing methodologies. By way of example, a 1,000 liter composting mixture within a batch reactor is well agitated by rotating a mechanical tumbler at a speed of 15 revolutions per minute. The composting proceeds for a period of 2 weeks to 52 weeks to facilitate metabolic breakdown of the manure. Preferably, fermentation lasts from 1 to 3 months with composting temperature, manure characteristics and composting inoculant being among the most important variables in composting duration.

Following the initial composting 20, a quantity of aquatic plant material and nitrogenous protein is added with optional rock dust 30. Typically, the aquatic vegetation is added in an amount from 10 percent to 200 weight percent that of the manure. More preferably, the aquatic vegetation is present from 10 percent to 40 percent by weight that of the manure. Still more preferably, the aquatic vegetation is present from 15 to 25 weight percent that of the manure. The aquatic vegetation serves as a source of minerals and plant hormones to the fermentation mixture and illustratively includes kelp, seaweed, sea grasses and algae. Kelp is the preferred aquatic vegetation. Optionally, in instances where soil enrichment with beta carotene is desired, an orange-colored algae such as Dunalea Selena is introduced in amounts from 0.1 to 10 percent of the original manure weight added.

The animal protein is a nitrogenous protein source and illustratively includes fish emulsion, offal, meat-trailings, -renderings and combinations thereof. In a preferred embodiment, the nitrogenous protein source is certified organic to preclude the addition of contaminants detrimental to fermentation flora growth. The nitrogenous protein is typically present from 50 percent to 800 weight percent that of the original manure added. Preferably, the nitrogenous protein is present from 120 percent to 300 percent by weight that of the manure originally added. Optionally, rock dust or other inorganic mineral sources are added to further condition soil. Rock dust operative herein illustratively includes limestone and volcanic rock. Preferably, the rock dust is volcanic.

Optionally, the fermentation stage occurs in the presence of an additional dose of plant material serving as a fermentation inoculant.

Preferably, the fermentation inoculant if introduced prior to the fermentation stage includes plant and vegetable based organic cultured bacteria 40. The plant and vegetable based cultured bacteria illustratively including annuals and perennials. It is appreciated that an additional quantity of water is readily added prior to or during the second stage of fermentation in order to facilitate viscosity control and agitation. Agitation and fermentation temperature conditions operative in the second fermentation stage are those detailed above with respect to the composting stage.

The supernate following the fermentation is then bottled for delivery to a site of application to soil 50. The supernate is composed of suspended bacteria, bacterial spores, fungal spores and/or yeasts. The fermentation supernate is characterized by having a free nitrogen content of less than 0.26 weight percent per total volume, a phosphorus content of between 30 and 250 milligrams per liter, and a potassium content of between 400 and 20,000 milligrams per liter. Nitrogen, phosphorus and potassium content of an inventive soil conditioner is summarized in Table 1.

TABLE 1

| Constituent | Typical | | Preferred | |
|---|---|---|---|---|
| Nitrogen % wt/vol | 0.1-3% | | 0.1-0.4% | |
| Phosphorus mg/L | 30-1,000 | mg/L | 50-500 | mg/L |
| Potassium mg/L | 1,000-20,000 | mg/L | 3,000-15,000 | mg/L |

While the present invention is detailed herein with respect to batch fermentation, it is appreciated that the inventive process is readily performed in a continuous flow reactor.

The present invention is further illustrated with reference to the following non-limiting examples. These examples are not intended to limit the scope of the appended claims.

### EXAMPLE 1

750 kilograms of organic cow manure is mixed within a vat type batch reactor equipped with a mechanical tumbler. A plant inoculant is introduced that includes 30 grams of yarrow blossoms, 30 grams of chamomile blossoms, 30 grams of stinging nettle whole plant in full bloom, 30 grams of oak bark, 30 grams of dandelion flowers, and 30 grams of valerian flowers. The resulting mixture is stirred at 15 revolutions per minute on average to maintain homogeneity of the mixture. The mixture is allowed to compost for 2 months at 28 degrees Celsius.

After 2 months 2,400 kilograms of certified organic fish emulsion, 240 kilograms kelp and 5 kilograms of rock dust is added to the now fermented mixture. 150 liters of plant based diazotroph bacterial culture is then added in addition to 30 grams yarrow blossoms, 30 grams chamomile blossoms, 30 grams stinging nettle whole plant in full bloom, 30 grams oak bark, 30 grams dandelion flowers, and 30 grams valerian flowers. 11,600 liters of filtered magnetized water is added and allowed to ferment for 2-52 weeks at 28 degrees Celsius with agitation and/or air bubblers. The resulting supernate is pH balanced to a pH of 8±1.5 and bottled. The resulting supernate contains 0.26 weight percent per volume nitrogen, 230 milligrams per liter phosphorus and 7,418 milligrams per liter potassium.

### EXAMPLE 2

The process of Example 1 was repeated with the addition of 1,000 grams of Dunalea Selena algae in concert with the bacterial culture. The resulting supernate after fermentation had similar nitrogen, phosphorus and potassium to the supernate of Example 1 as well as 500,000 milligrams per liter beta carotene.

### EXAMPLE 3

A comparison of the ability of an inventive soil conditioner to simulate plant growth was undertaken relative to comparative product, Jungle Juice™ (AGM Foods, Queensland, Australia). Three tomato plants are grown in identically prepared plots with each plant being at the center of a 1 meter square grid square. Each of the compositions is applied according to use instructions with the inventive composition of Example 1 being applied in a quantity equal to that of Jungle Juice™. The compositions are applied 2 weeks after germination in a single dosage. Twelve weeks later, the plants are harvested and weighed. The plant mass is then normalized. The results are summarized in Table 2.

TABLE 2

| | Nitrogen | Phosphorus | Potassium | Normalized |
|---|---|---|---|---|
| | % wt/vol | mg/L | mg/L | Plant Mass |
| Example 1 | 0.26 | 220 | 7418 | 1.0 |
| Jungle Juice | 0.06 | 284 | 4967 | 0.52 |

Any patents or publications mentioned in the specification are indicative of the levels of those skilled in the art to which the invention pertains. These patents and publications are herein incorporated by reference to the same extent as if each individual patent or publication was specifically and individually indicated to be incorporated by reference.

The foregoing description is illustrative of particular embodiments of the invention, but is not meant to be a limitation upon the practice thereof. Modifications that remain within the spirit of the invention will be apparent to one skilled in the art upon reading the specification; these modifications and equivalents thereof are intended to be encompassed within the appended claims.

1. A soil conditioner comprising: a bacterial culture having more than 0.20 weight percent per volume nitrogen, from 30 to 250 milligrams per liter phosphorus and from 400 to 20,000 milligrams per liter potassium.

2. The soil conditioner of claim 1 wherein the pH is between 7.5 and 9.5.

3. The soil conditioner of claim 1 further comprising beta carotene.

4. The soil conditioner of claim 1 further comprising omega fatty acids.

5. The soil conditioner of claim 1 further comprising trace minerals.

6. The soil conditioner of claim 1 wherein said bacterial culture is diazotroph.

7. The soil conditioner of claim 1 wherein the phosphorus content is between 200 and 250 milligrams per liter.

8. A process for preparing a soil conditioner comprising the steps of:
composting a manure with at least one plant inoculant to yield a composted mixture; and
fermenting said composted mixture in combination with a nitrogenous protein source and seaweed.

9. The process of claim 8 wherein said manure is selected from the group consisting of: human, cow, pig, sheep, fowl, mushroom compost, and combinations thereof.

10. The process of claim 8 wherein said manure is certified organic.

11. The process of claim 8 wherein said at least one plant inoculant is selected from the group consisting of: yarrow, dandelion, valerian, and combinations thereof.

12. The process of claim 11 wherein said at least one plant inoculant comprises yarrow blossoms, chamomile blossoms, whole plant in full bloom of stinging nettle, oak bark, dandelion flower and valerian flower.

13. The process of claim 8 wherein composting occurs for a time ranging from 2 weeks to 52 weeks.

14. The process of claim 8 wherein composting occurs at a temperature between 10 and 70 degrees Celsius.

15. The process of claim 8 wherein composting occurs with agitation.

16. The process of claim 8 further comprising a desiccant present during composting.

17. The process of claim 16 wherein said desiccant is selected from the group consisting of: zeolites; anhydrous or partially hydrated salts, such as calcium chloride; and calcium sulfate.

18. The process of claim 8 wherein the weight ratio of said manure:water:said at least one plant fermentation inoculant is 100-1000:1.

19. The process of claim 8 wherein said nitrogenous protein source is selected from the group consisting of: fish emulsion, offal, meat-trailings, -renderings, and combinations thereof.

20. The process of claim 8 wherein said nitrogenous protein source is certified organic.

21. The process of claim 8 further comprising rock dust present during fermenting.

22. The process of claim 8 further comprising the step of adding a second dose of said at least one plant inoculant prior to or during fermenting.

23. The process of claim 8 further comprising the step of adding a plant bacterial culture prior to or during fermenting.

24. The process of claim 8 further comprising the step of: adding algae prior to or during fermenting.

25. The process of claim 24 wherein said algae is an orange algae.

26. The process of claim 8 wherein fermenting occurs for a period of from 2 weeks to 52 weeks.

27. The process of claim 8 wherein fermenting occurs at a temperature from 10 to 40 degrees Celsius.

28. The process of claim 8 wherein fermenting occurs with agitation.

29. The process of claim 8 further comprising the step of pH balancing the soil conditioner after fermenting.

30. The use of a soil conditioner according to claim 1 as a livestock nutritional supplement.

31. The use of the soil conditioner according to claim 1 as an oil spill degradant.
